(19) United States
(12) Patent Application Publication
(10) Pub. No.: US 2005/0022348 A1
(43) Pub. Date: Feb. 3, 2005

(54) Personalized interior overlay for a casket

(76) Inventors: Daniel J. Parker, Connersville, IN (US); Jamie D. Riddle, Sunman, IN (US); Christopher M. Wessel, Metamora, IN (US)

Correspondence Address: WOOD, HERRON & EVANS, LLP, 2700 CAREW TOWER, 441 VINE STREET, CINCINNATI, OH, 45202, US

(21) Appl. No.: 10/632,526

(22) Filed: Aug. 1, 2003

(51) Int. Cl. A61G 17/00

(52) U.S. Cl. 27/20

(57) ABSTRACT

A casket comprises a shell having a pair of opposed side walls and a pair of opposed end walls, a lid closeable upon the shell, a first piece of decorative fabric overlaying at least a portion of at least one of the walls and a second piece of decorative fabric overlaying at least a portion of the first piece of decorative fabric, the second piece of decorative fabric being personalized to a deceased in the casket by including text and/or graphics memorializing the deceased thereon.

### FIELD OF THE INVENTION

This invention relates generally to the death care industry, and more particularly to personalized caskets for memorializing a deceased.

### BACKGROUND OF THE INVENTION

Upon the death of a family member the surviving loved one of the deceased must make a number of decisions, including what type of funeral or other memorial service to hold, preparation of the body, selection of a suitable casket or cremation urn, etc. In the death care industry it is conventional for those decisions to be made in a so-called “arrangement conference.” In an arrangement conference, the funeral director meets with the surviving loved one of the deceased, typically in the funeral home of the funeral director, and describes to and discusses with the surviving loved one the various funeral products and services which are available. The funeral director may use visual aids such as a product catalog, product display board (such as that disclosed in the Assignee's U.S. Pat. No. 5,787,626 titled Funeral Product Display Case hereby incorporated by reference herein) and a casket selection room (such as that disclosed in the Assignee's U.S. Pat. No. 5,405,017 titled Modular Casket Display System and in the Assignee's pending application Ser. No. 09/638,576 titled Display For A Casket Selection and/or Viewing Room both hereby incorporated by reference herein) to illustrate the products available to the customer.

There is a trend in the death care industry to make efforts towards “personalizing” the funeral products and the funeral or other memorial service purchased for the deceased to provide a more meaningful memorial experience for the family and friends of the deceased. One of the earlier attempts at providing a means of personalizing or customizing a casket to the deceased may be seen with reference to the Assignee's U.S. Pat. No. 4,457,054 titled Casket Shelf, hereby incorporated by reference herein. That patent discloses a casket shelf which is mounted to the dish assembly of the head end cap when the head end cap is in the open position. The shelf provides a surface for supporting and displaying articles of religious or personal significance to the deceased.

Many casket manufacturers and funeral directors now manufacture and offer many “custom modular” variations of caskets, rather than selling mere “cookie cutter” or “one size fits all” caskets, thereby allowing the loved one to in essence design a specific casket especially suited or tailored to the deceased. For example, customers can select from a number of casket materials, casket finishes, casket corner adornments and casket interiors. Advances made in the area of “quick change” and “tool less” fastening mechanisms have greatly facilitated the rapid removal of one accessory from the casket and the rapid installation of another more desirable accessory to the casket. In addition to promoting personalization of the casket to the deceased, such interchangeability greatly reduces the amount of inventory the funeral director must keep on hand. An example may be seen in the Assignee's pending application Ser. No. 09/660,574 titled Quick Change Casket Corner Attachment Mechanism and hereby incorporated by reference herein, commercially available as the LifeSymbols® line of interchangeable corner adornments available from Batesville®.

The “custom” casket interiors available to the funeral customer today include not only the internal lining material of the casket (which itself may also be of the quick-change type, see the Assignee's U.S. Pat. No. 5,784,768 titled Casket Having Quickly Interchangeable And Adjustable Interior and hereby incorporated by reference herein) but also the decorative cap panels that fit within the underneath of the casket cap which serve to present a visually aesthetically pleasing appearance to the underside of the cap when in the open position. The cap panel can be embroidered with a favorite saying of the deceased, a scene depicting the deceased's hobby, etc. Special cap panels have even been designed which, in addition to performing a memorial function while installed in the casket, are adapted to be presented to the loved one surviving the deceased to be displayed by the loved one in his or her home as a keepsake. See the Assignee's U.S. Pat. Nos. 6,237,202 and 6,446,315 both titled Dish Assembly For A Burial Casket Cap and hereby incorporated by reference herein, the subject of which is commercially available as the MemoryFrame™ line of cap panels available from Batesville®. The casket can also include a memorabilia drawer in which keepsakes of the deceased can be stored and displayed, as disclosed in the Assignee's U.S. Pat. Nos. 5,611,124 and 5,727,291 both titled Casket Having Memorabilia Compartment and hereby incorporated by reference herein, commercially available as the MemorySafe® line of caskets including memorabilia drawers available from Batesville®.

Advances have therefore been made in the area of “personalization” of funeral products as demonstrated with the novel products discussed above. However, there continues to be room for improvement in the area of personalization in the death care industry.

### SUMMARY OF THE INVENTION

The invention is a casket comprising a shell having a pair of opposed side walls and a pair of opposed end walls; a lid closeable upon the shell; a first piece of decorative fabric overlaying at least a portion of at least one of the walls; and a second piece of decorative fabric overlaying at least a portion of the first piece of decorative fabric, the second piece of decorative fabric being personalized to a deceased in the casket by including text and/or graphics memorializing the deceased thereon.

The first piece of decorative fabric can be a small body overlaying an interior side of a head end portion of at least one of the pair of side walls of the casket shell.

The casket can further include means for removably securing the second piece of decorative fabric to the first piece of decorative fabric.

The second piece of decorative fabric can comprise a generally rectangular fabric sheet having first and second portions, the second portion folded over on and secured to the first portion so as to form a sleeve; a stay in the sleeve; and a fastener secured to the sleeve for removably securing the second piece of decorative fabric to the first piece of decorative fabric.

The fastener can be secured to the sleeve and the text and/or graphics can be applied to the first portion of the sheet in such a manner that the fastener and the text and/or graphics face in the same direction prior to securement of the second piece of decorative fabric to the first piece of decorative fabric; the sleeve can be folded over on the first portion of the sheet so that the fastener and the text and/or graphics face in the opposite direction after securement of the second piece of decorative fabric to the first piece of decorative fabric.

The fastener can be double-sided tape.

In another aspect, the invention is a method of personalizing a casket for a deceased to be displayed in the casket, comprising providing the casket having a shell, a lid closeable upon the shell and a first piece of decorative fabric overlaying at least a portion of at least one of an interior and an exterior of the shell; providing a second piece of decorative fabric; applying at least one of text and graphics, personal to the deceased, to the second piece of decorative fabric; and overlaying at least a portion of the first piece of decorative fabric with the second piece of decorative fabric.

In yet another aspect, the invention is a method of personalizing a casket for a deceased to be displayed in the casket, comprising providing the casket having a shell, a lid closeable upon the shell and a first piece of decorative fabric overlaying at least a portion of at least one of an interior and an exterior of the shell, the first piece of decorative fabric having top, bottom and side edges; providing a second piece of decorative fabric having top, bottom and side edges; applying at least one of text and graphics, personal to the deceased, to the second piece of decorative fabric; folding the top edge of the second piece of decorative fabric over onto a rear side thereof; attaching the folded top edge of the second piece of decorative fabric to the top edge of the first piece of decorative fabric; and folding the side edges of the first piece of decorative fabric inwardly behind the side edges of the second piece of decorative fabric.

In still another aspect, the invention is a casket comprising a casket shell, a casket lid closeable upon the shell, a decorative sheet-like substrate positioned over at least a portion of either the shell or the lid and a decorative sheet-like overlay removably secured to the substrate, the overlay being personalized to the deceased in the casket by including text and/or graphics memorializing the deceased.

The substrate can be decorative fabric of the casket, the small body of the shell, the big body of the shell, the overthrow of the shell or the puffing of the lid. The overlay can be manufactured of fabric or a rigid or semi-rigid material, such as metal, wood or plastic. The overlay can be removably secured to the substrate with a fastener, or the overlay can be removably secured to the substrate by positioning the overlay in a pocket mounted to the substrate. The pocket can be a frame.

The invention thus provides a personalized burial product on an at-need basis, enabling a manufacturer to promptly manufacture and deliver a personalized feature in a casket product at a relatively low cost.

These and other features and advantages of the present invention will become more readily apparent during the following detailed description taken in conjunction with the drawings herein, in which:

### BRIEF DESCRIPTION OF THE DRAWINGS OF THE INVENTION

FIG. 1 is a perspective view of a casket including the personalized interior overlay of the present invention;

FIG. 2 is a perspective view of the personalized interior overlay of FIG. 1, enlarged;

FIG. 3A is view taken along line 3A-3A of FIG. 2;

FIG. 3B is a view similar to FIG. 3A illustrating the step of folding the top edge of the personalized interior overlay over onto the back side thereof prior to pressing the double-sided tape of the personalized interior overlay to the small body of the casket shell;

FIG. 4 is a view similar to FIG. 2 illustrating the personalized interior overlay folded as shown in FIG. 3B for attachment to the small body; and

FIG. 5 is a view similar to FIG. 4 illustrating the final step of folding the side edges of the personalized interior overlay inwardly behind the side edges of the small body; and

FIGS. 6-11 illustrate various alternative embodiments of the personalized interior overlay of the present invention.

### DETAILED DESCRIPTION OF A PREFERRED EMBODIMENT OF THE INVENTION

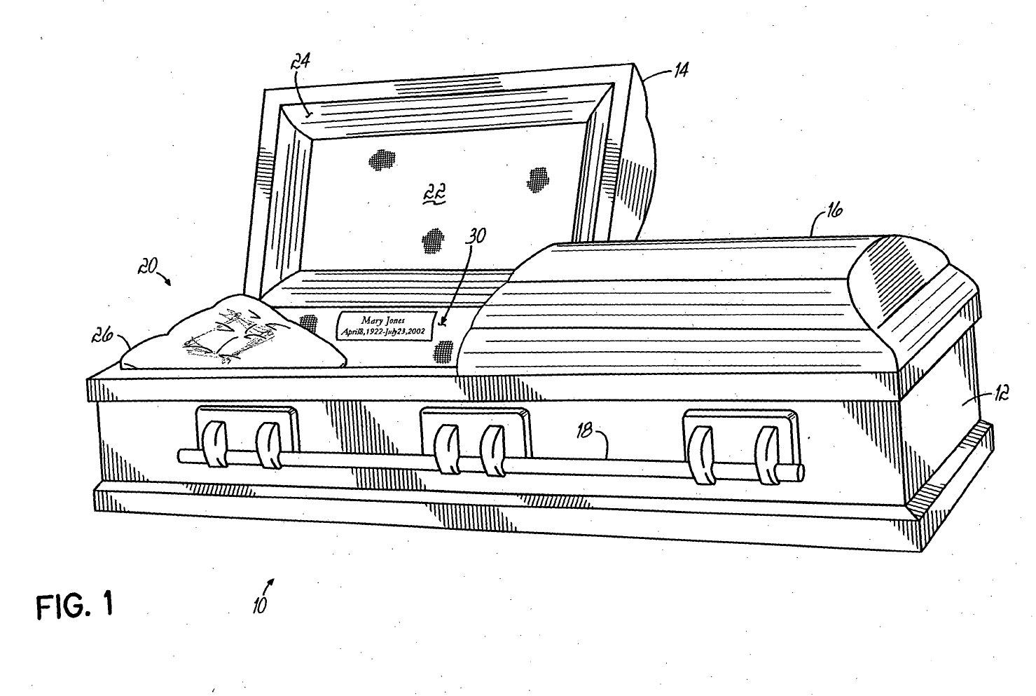

With reference to FIG. 1, there is illustrated a casket 10 according to the invention. The casket 10 includes a lower body containing portion or shell 12, a head end cap 14 which can be pivoted to a rear upper edge of the shell 12 and a foot end cap 16 which likewise can be pivoted to the rear upper edge of the shell 12. Casket 10 can include handling apparatus 18 and a decorative interior 20.

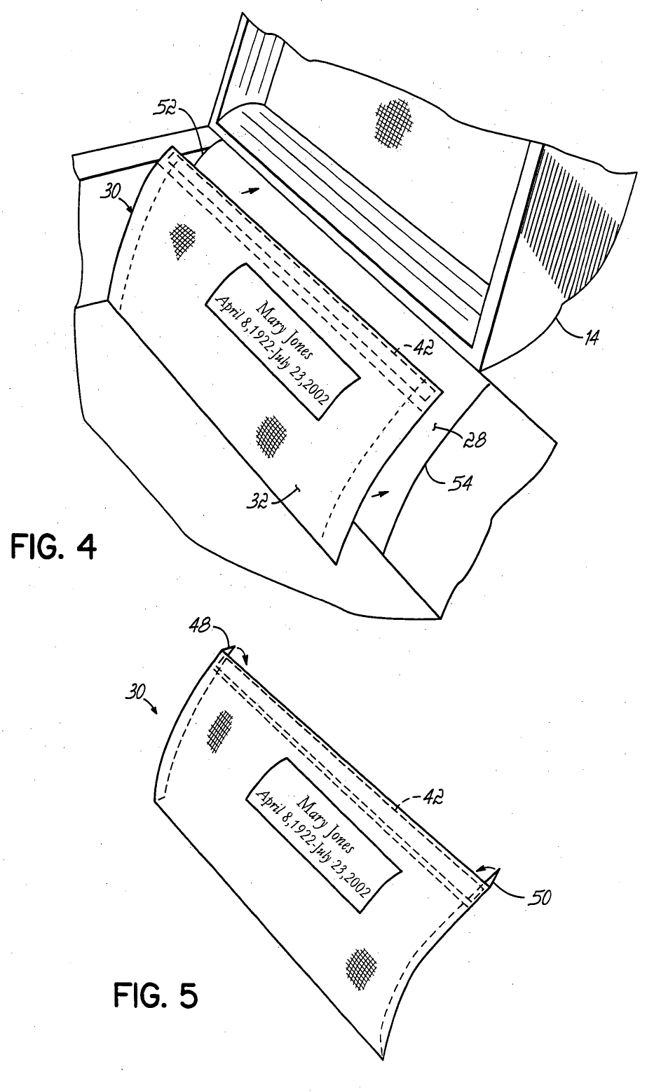

Decorative interior 20 can include a cap panel 22 including a peripheral puffing 24 therearound, mounted to the underside of the head end cap 14. Cap panel 22 and puffing 24 can be fabricated of fabric-covered sheet-like material (“chipboard”). Interior 20 can further include a pillow 26 (with or without a pillow “case”) and “shirred” or other decorative fabric portions lining the interior walls of the casket shell 12. Each of the decorative fabric portions lining the interior walls of the casket shell 12 is known as a “small body.” A small body 28 lining the head end portion of the side wall of the casket shell 12 carrying the hinge connections of the caps 14, 16 to the shell 12 is shown in FIG. 4. In addition, the side wall of the casket shell 12 opposite the hinge connections of the caps 14, 16 to the shell 12 can carry an additional, larger piece of shirred or other decorative fabric, known as a “big body,” for overlaying the top edge of the casket shell during periods when the casket cap 14 is opened for presentation and viewing of the deceased (big body not shown in FIG. 1). For further description of big and small bodies see the Assignee's U.S. Pat. No. 5,784,768. It is contemplated that the invention of the personalized interior overlay 30 is usable with either or both of the big and small bodies.

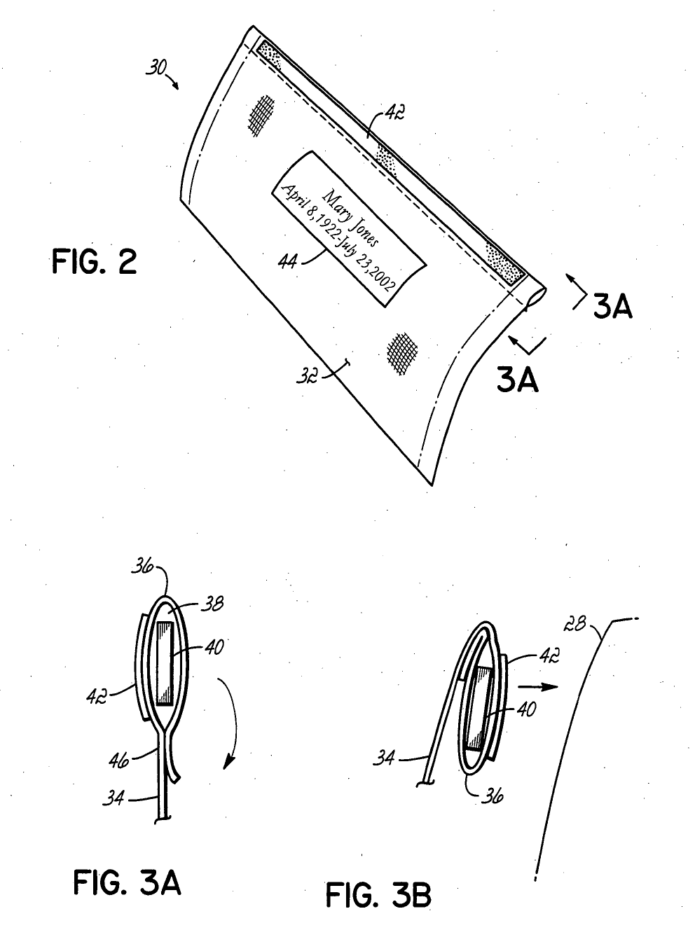

Referring now to FIGS. 2 and 3A, the personalized interior overlay 30 is illustrated in more detail. The overlay 30 can comprise a sheet-like structure having any suitable shape fabricated from any suitable material. For example, overlay 30 can comprise a generally rectangular fabric sheet 32 having first 34 and second 36 portions, with the second portion 36 being folded over on and secured, as by sewing or the like, to the first portion 34 so as to form a sleeve 38. A stay 40 can be positioned in the sleeve 38 to provide rigidity. Stay 40 can be fabricated of any suitable material, for example cardboard, plastic, metal etc. A fastener 42, for example double-sided tape, hook and loop fasteners, buttons, snaps or the like, can be secured to the sleeve 38 for removably securing the personalized interior overlay 30 to the small body 28. Alternatively, sleeve 38 could be eliminated and stay 40 could be secured to overlay 30 with double-sided tape, hook and loop fasteners, buttons, snaps, staples, stitching, adhesives, etc.

As shown in FIG. 2, personalized interior overlay 30 can include text and/or graphics 44, personal to the deceased. Text and/or graphics 44 can be applied to the personalized interior overlay 30 by most any means such as embroidery, adhesives, ironing on, ink, hot stamping or other heat transfer, silk screening or the like. Double-sided tape 42 is applied to the same side of the overlay 30 as is the text and/or graphics 44. Accordingly, when the top edge of the overlay 30 is folded over onto the rear side of the overlay 30 so that double-sided tape 42 faces and can be adhered to small body 28, seam 46 where first and second portions 34 and 36 of fabric sheet 32 are sewn together is not visible to an onlooker.

Once double-sided tape 42 is pressed firmly to the top edge of the small body 28, the side edges 48, 50 of the overlay 30 can be folded inwardly behind the side edges 52, 54 of the small body 28, respectively.

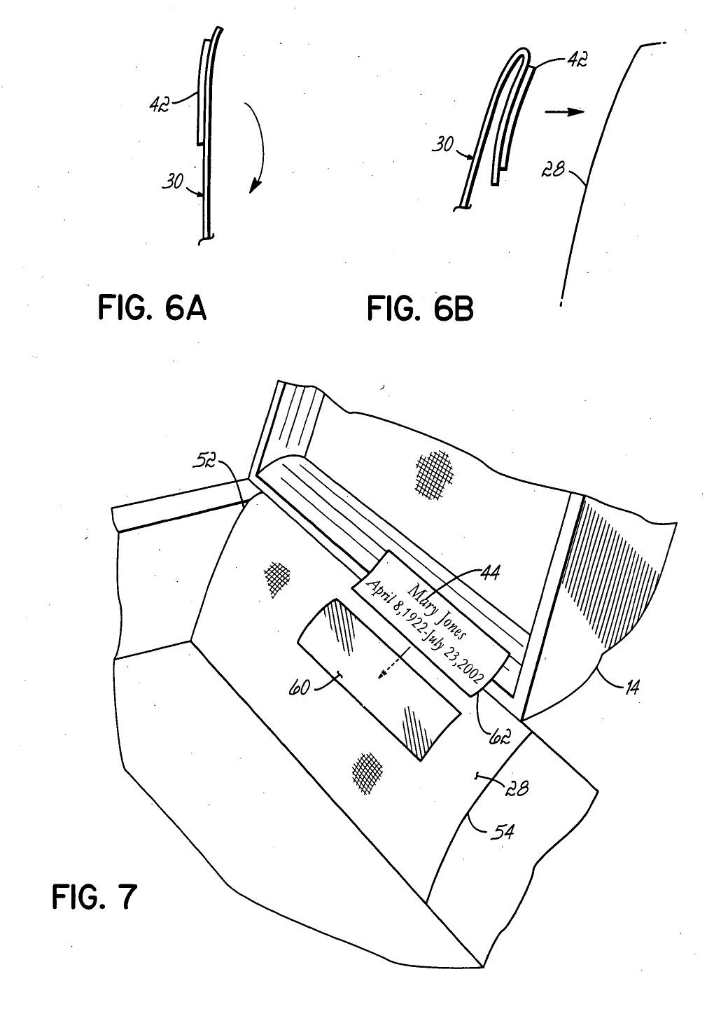

Referring now to FIGS. 6-11, and with like numbers designating like elements, various alternative embodiments of the present invention are illustrated. For example, and referring first to FIGS. 6A and 6B, it will be seen that sleeve 38 and/or stay 40 can be eliminated from the overlay 30. In that case, overlay 30 only fastener 42. Preferably, but not necessarily, fastener 42 will be attached to overlay 30 on the same side of the as the text and/or graphics 44. In that case, and as in the prior embodiment, when the top edge of the overlay 30 is folded over onto the rear side of the overlay 30 so that double-sided tape 42 faces and can be adhered to small body 28, the fastener 42 and top edge of the overlay 30 are not visible to an onlooker.

FIG. 7 illustrates an embodiment of the invention wherein a pocket 60 is affixed to the small body 28. Pocket 60 receives a placard, plaque or other rigid or semi-rigid sheet-like structure 62 of metal, wood, plastic or the like including text and/or graphics 44 thereon. Pocket 60 can be affixed to small body 28 in any suitable manner, such as by double-sided tape, hook and loop fasteners, buttons, snaps, staples, stitching, adhesives, etc. Pocket 60 is preferably fabricated out of transparent or translucent material to permit an onlooker to view the plaque 62 there through. To that end, pocket 60 can be made of mesh fabric material, transparent or translucent plastic sheet material, etc. For that matter pocket 60 could be fabricated simply as a frame behind which plaque 62 is slid, such that the frame forms a peripheral border around the plaque 62 when installed.

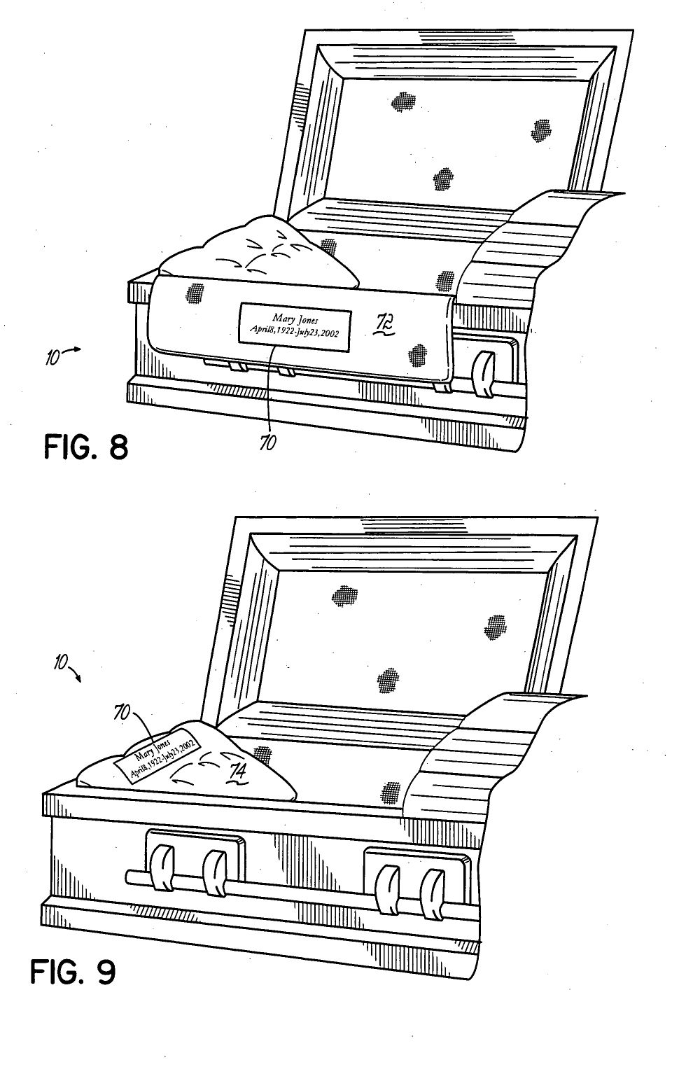

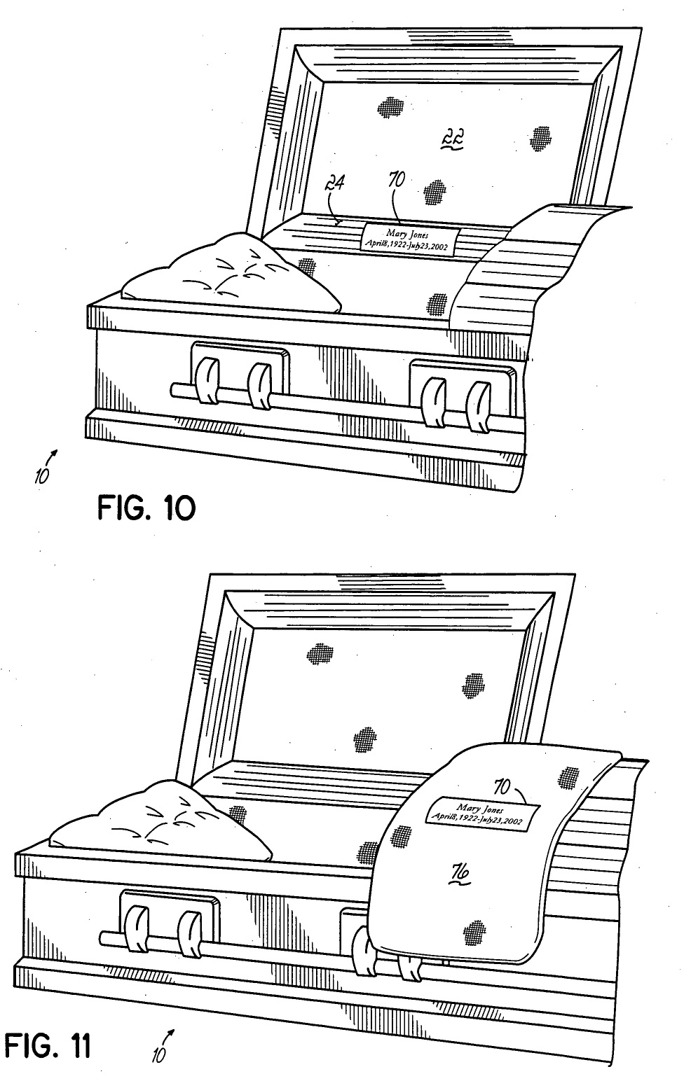

Referring now to FIGS. 8-11, various additional alternative embodiments of the present invention are illustrated. In each of the various alternative embodiments illustrated the invention could be practiced like that shown in FIGS. 1-5, i.e. as an overlay, as well as like that shown in FIG. 7, i.e. as a plaque displayed in a pocket or frame. More particularly, and using the element numeral 70 to generically embrace both the overlay 30 and plaque/pocket/frame 60, 62, FIG. 8 illustrated the personalization device 70 mounted to the big body 72 of the casket 10. FIG. 9 illustrates the personalization device 70 mounted to the pillow case and/or pillow 74 of the casket 10. FIG. 10 illustrates the personalization device 70 mounted to the cap panel 22 and in particular to the puffing 24. FIG. 11 illustrates the personalization device 70 mounted to the overthrow 76 of the casket 10. All such variations are considered to be within the scope of the present invention.

Those skilled in the art will readily recognize numerous adaptations and modifications which can be made to the present invention which will result in an improved personalized interior overlay for a casket, yet all of which will fall within the spirit and scope of the present invention as defined in the following claims. Accordingly, the invention is to be limited only by the scope of the following claims and their equivalents.

1. A casket comprising:
a shell having a pair of opposed side walls and a pair of opposed end walls;
a lid closeable upon said shell;
a first piece of decorative fabric overlaying at least a portion of at least one of said walls; and
a second piece of decorative fabric overlaying at least a portion of said first piece of decorative fabric, said second piece of decorative fabric being personalized to a deceased in the casket by including at least one of text and graphics memorializing the deceased thereon.

2. The casket of claim 1 wherein said first piece of decorative fabric is a small body overlaying an interior side of a head end portion of at least one of said pair of side walls.

3. The casket of claim 1 further including means for removably securing said second piece of decorative fabric to said first piece of decorative fabric.

4. The casket of claim 1 wherein said second piece of decorative fabric comprises:
a generally rectangular fabric sheet having first and second portions, said second portion folded over on and secured to said first portion so as to form a sleeve;
a stay in said sleeve; and
a fastener secured to said sleeve for removably securing said second piece of decorative fabric to said first piece of decorative fabric.

5. The casket of claim 4 wherein said fastener is secured to said sleeve and said at least one of said text and graphics is applied to said first portion of said sheet in such a manner that said fastener and said at least one of said text and graphics face in the same direction prior to securement of said second piece of decorative fabric to said first piece of decorative fabric, and wherein said sleeve is folded over on said first portion of said sheet so that said fastener and said at least one of said text and graphics face in the opposite direction after securement of said second piece of decorative fabric to said first piece of decorative fabric.

6. The casket of claim 4 wherein said fastener is double-sided tape.

7. A method of personalizing a casket for a deceased to be displayed in the casket, comprising:
providing the casket having a shell, a lid closeable upon the shell and a first piece of decorative fabric overlaying at least a portion of at least one of an interior and an exterior of the shell;
providing a second piece of decorative fabric;
applying at least one of text and graphics, personal to the deceased, to the second piece of decorative fabric; and
overlaying at least a portion of the first piece of decorative fabric with the second piece of decorative fabric.

8. The method of claim 7 wherein the first piece of decorative fabric is a small body overlaying the interior of a head end portion of the shell.

9. The method of claim 7 wherein the casket further includes means for removably securing the second piece of decorative fabric to the first piece of decorative fabric.

10. The method of claim 7 wherein the second piece of decorative fabric comprises:
a generally rectangular fabric sheet having first and second portions, the second portion folded over on and secured to the first portion so as to form a sleeve;
a stay in the sleeve; and
a fastener secured to the sleeve for removably securing the second piece of decorative fabric to the first piece of decorative fabric.

11. The method of claim 10 wherein the fastener is secured to the sleeve and the at least one of the text and graphics is applied to the first portion of the sheet in such a manner that the fastener and the at least one of the text and graphics face in the same direction prior to securement of the second piece of decorative fabric to the first piece of decorative fabric, and wherein the sleeve is folded over on the first portion of the sheet so that the fastener and the at least one of said text and graphics face in the opposite direction after securement of the second piece of decorative fabric to the first piece of decorative fabric.

12. The method of claim 10 wherein the fastener is double-sided tape.

13. A method of personalizing a casket for a deceased to be displayed in the casket, comprising:
providing the casket having a shell, a lid closeable upon the shell and a first piece of decorative fabric overlaying at least a portion of at least one of an interior and an exterior of the shell, the first piece of decorative fabric having top, bottom and side edges;
providing a second piece of decorative fabric having top, bottom and side edges;
applying at least one of text and graphics, personal to the deceased, to the second piece of decorative fabric;
folding the top edge of the second piece of decorative fabric over onto a rear side thereof;
attaching the folded top edge of the second piece of decorative fabric to the top edge of the first piece of decorative fabric; and
folding the side edges of the first piece of decorative fabric inwardly behind the side edges of the second piece of decorative fabric.

14. The method of claim 13 wherein the first piece of decorative fabric is a small body overlaying the interior of a head end portion of the shell.

15. The method of claim 13 wherein the casket further includes means for removably securing the second piece of decorative fabric to the first piece of decorative fabric.

16. The method of claim 13 wherein the second piece of decorative fabric comprises:
a generally rectangular fabric sheet having first and second portions, the second portion folded over on and secured to the first portion so as to form a sleeve;
a stay in the sleeve; and
a fastener secured to the sleeve for removably securing the second piece of decorative fabric to the first piece of decorative fabric.

17. The method of claim 16 wherein the fastener is double-sided tape.

18. A casket comprising:
a casket shell;
a casket lid closeable upon said casket shell;
a decorative sheet-like substrate positioned over at least a portion of at least one of said shell and lid; and
a decorative sheet-like overlay removably secured to said substrate, said overlay being personalized to a deceased in the casket by including at least one of text and graphics memorializing the deceased thereon.

19. The casket of claim 18 wherein said substrate is decorative fabric of said casket.

20. The casket of claim 18 wherein said substrate is a small body of said shell.

21. The casket of claim 18 wherein said substrate is a big body of said shell.

22. The casket of claim 18 wherein said substrate is an overthrow of said shell.

23. The casket of claim 18 wherein said substrate is a puffing of said lid.

24. The casket of claim 18 wherein said overlay is manufactured from fabric.

25. The casket of claim 18 wherein said overlay is manufactured of one of a rigid material and a semi-rigid material.

26. The casket of claim 25 wherein said overlay is manufactured of metal.

27. The casket of claim 25 wherein said overlay is manufactured of wood.

28. The casket of claim 25 wherein said overlay is manufactured of plastic.

29. The casket of claim 18 wherein said overlay is removably secured to said substrate with a fastener.

30. The casket of claim 18 wherein said overlay is removably secured to said substrate by positioning said overlay in a pocket mounted to said substrate.

31. The casket of claim 30 wherein said substrate is a decorative fabric of said casket.

32. The casket of claim 30 wherein said substrate is a small body of said shell.

33. The casket of claim 30 wherein said substrate is a big body of said shell.

34. The casket of claim 30 wherein said substrate is an overthrow of said shell.

35. The casket of claim 30 wherein said substrate is a puffing of said lid.

36. The casket of claim 30 wherein said pocket is a frame.
